(19) United States
(12) Patent Application Publication
(10) Pub. No.: US 2006/0245890 A1
(43) Pub. Date: Nov. 2, 2006

(54) Apparatus and method for transporting and dispensing a strap

(75) Inventors: Jerry Franklin Hartman, Denton, NC (US); Sammy Lee Barringer, Denton, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Lowe's Companies, Inc.

(21) Appl. No.: 11/087,373

(22) Filed: Mar. 23, 2005

(51) Int. Cl. B66F 9/18

(52) U.S. Cl. 414/607

(57) ABSTRACT

A system for transporting and dispensing strap from a reel is provided. The system includes a lifting device and a strap dispensing apparatus. The strap dispensing apparatus includes a base member having first and second sides. The first side of the base member defines at least one channel that is structured to be transportably engaged by the lifting device. The strap dispensing apparatus also includes a frame mounted to the second side of the base member. The frame is structured to rotatably support the reel so that the strap can be dispensed.

### FIELD OF THE INVENTION

The present invention is related to freight packaging and transportation and, more particularly, to an apparatus and method for dispensing strap used to package and/or secure freight.

### BACKGROUND OF THE INVENTION

When packaging and/or loading freight for transportation, it is common to secure the freight and/or packaging for the freight using a metal band or strap. Once the strap is in place, the ends of the strap can then be secured together using a pressure-fitted fastener. For example, some commercial companies market and distribute various manual and automated strap dispensers and systems. When using the strap dispensers at a large facility, it is common for workers to utilize forklifts to transport the dispensers from one point to another. However, it has been found that the use of a forklift to transport a conventional strap dispenser oftentimes results in damage to the frame of the strap dispensers when the dispensers are being lifted or put down by the forklift. Eventually, this damage can render the dispensers inoperative.

Thus, there remains a need for an apparatus and method that facilitates the portability of a strap dispenser without causing damage to the dispenser frame. The apparatus and method should be cost-effective and commercially efficient, allowing workers to use the strap dispenser at several different locations in a short period of time.

### BRIEF SUMMARY OF THE INVENTION

The present invention provides an apparatus for dispensing strap from a reel that is transportable using a lifting device. According to one embodiment, the apparatus includes a base member having first and second sides. The first side of the base member including at least one channel that is structured to be transportably engaged by the lifting device. The apparatus includes a frame mounted to the second side of the base member. The frame is structured to rotatably support the reel so that the strap can be dispensed. In one embodiment, the frame is rotatably mounted to the second side of the base member such that the frame can be rotated between first and second positions, wherein the first position is substantially vertical and the second position is substantially horizontal. In another embodiment, the apparatus comprises a pair of wheels and an axle extending therebetween, wherein the pair of wheels and the axle are rotatably mounted to the frame. In still another embodiment, the apparatus includes a connector structured to mount the axle to the second side of the base member so that the frame is rotatably mounted to the base member. In one embodiment, the connector has a generally V-shaped configuration.

The present invention also provides a system for transporting and dispensing strap from a reel. In one embodiment, the system includes a lifting device and a strap dispensing apparatus. The strap dispensing apparatus includes a base member having first and second sides. The first side of the base member including at least one channel that is structured to be transportably engaged by the lifting device. The strap dispensing apparatus also includes a frame mounted to the second side of the base member. The frame is structured to rotatably support the reel so that the strap can be dispensed.

The present invention provides a method for transporting a strap dispensing apparatus. According to one embodiment, the method includes providing a strap dispensing apparatus having a base member with first and second sides. The first side of the base member including at least one channel. The strap dispensing apparatus further includes a frame mounted to the second side of the base member, wherein the frame is structured to rotatably support a strap reel so that the strap can be dispensed. The method includes mounting the base member on the lifting device. In one embodiment, the mounting step includes inserting a fork of the lifting device in the channel of the base member. The method includes transporting the strap dispensing apparatus with the lifting device. In one embodiment, the transporting step includes lifting the strap dispensing apparatus with the lifting device. In another embodiment, the transporting step includes moving the strap dispensing apparatus with the lifting device. In yet another embodiment, the transporting step includes lowering the strap dispensing apparatus with the lifting device.

The present invention also provides a method for replacing a strap reel on a strap dispensing device. According to one embodiment, the method includes providing a strap dispensing apparatus having a base member. The strap dispensing apparatus further comprising a frame mounted to the base member, wherein the frame is structured to rotatably support a strap reel so that the strap can be dispensed. The method includes rotating the frame from a first position to a second position on the base member, wherein the first position is substantially vertical and the second position is substantially horizontal. In one embodiment, the method includes releasing a connector securing the frame to the base member prior to the first rotating step. The strap reel is removed. The strap reel is then replaced. The method then includes rotating the frame from the second position to the first position on the base member. In one embodiment, the method includes securing the connector securing the frame to the base member subsequent to the second rotating step.

Thus, there is provided an apparatus and method that facilitates the portability of a strap dispenser without causing damage to the dispenser frame. The apparatus and method is cost-effective and commercially efficient, allowing workers to use the strap dispenser at several different locations in a short period of time and to easily and safely replace the strap reel.

### BRIEF DESCRIPTION OF THE DRAWINGS

Having thus described the invention in general terms, reference will now be made to the accompanying drawings, which are not necessarily drawn to scale, and wherein:

FIG. 1 is a perspective view illustrating a portable strap dispenser, according to one embodiment of the present invention;

FIG. 2 is an exploded perspective view illustrating the portable strap dispenser of FIG. 1;

FIG. 3 is a partial perspective view illustrating the back of the portable strap dispenser of FIG. 1;

FIG. 4 is a partial cross-sectional view illustrating the second connector of the portable strap dispenser of FIG. 1;

FIG. 5 is a partial cross-sectional view illustrating the frame of the portable strap dispenser of FIG. 1 being rotated about the second connector;

FIG. 6 is a perspective view illustrating the frame of the portable strap dispenser of FIG. 1 being rotated about the second connector;

FIG. 7 is a perspective view illustrating the frame of the portable strap dispenser of FIG. 1 in position for replacement of the strap reel;

FIG. 8 is an exploded perspective view illustrating the strap reel of the portable strap dispenser of FIG. 1 being removed;

FIG. 9 is an exploded perspective view illustrating the strap reel of the portable strap dispenser of FIG. 1 being replaced; and

FIG. 10 is an exploded perspective view illustrating the portable strap dispenser of FIG. 1 being connected to a lifting device.

### DETAILED DESCRIPTION OF THE INVENTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout.

Referring to FIG. 10, there is illustrated a system 10 for transporting and dispensing strap 12 from a reel 14. The system includes a lifting device 16 and a strap dispensing apparatus 18. The lifting device 16 can include a forklift or other device capable of transporting the strap dispensing apparatus 18, including lifting and lowering the strap dispensing apparatus and moving the apparatus from one location to another.

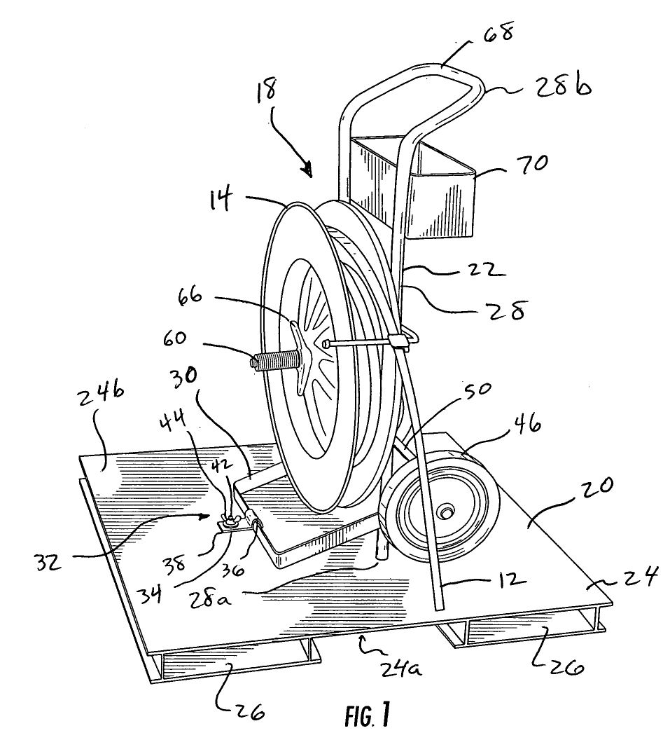

The strap dispensing apparatus 18 is structured to dispense strap from the reel 14 and to be transportable using the lifting device 16. According to one embodiment of the present invention, as illustrated in FIGS. 1 and 10, the strap dispensing apparatus 18 includes a base member 20, a frame 22, and a strap reel 14. The base member 20 is structured to support the frame 22 and strap reel 14 and to be mounted on the lifting device 16. For example, the base member 12 can comprise a plate 24 having first and second sides 24a,b, wherein the first side 24a is structured to be transportably engaged by the lifting device 16 and the frame 22 is mounted to the second side 24b. In one embodiment, the plate 24 is formed of steel and generally has a rectangular configuration in which the width is approximately 3 feet, the length is approximately 3 feet and the thickness is approximately ¼ inch. Where the lifting device 16 comprises a forklift, the first side 24a of the base member 12 can include one or more channels 26 configured to receive the forks 16a of the forklift. In one embodiment, the base member 20 includes two channels 26 formed of steel. Each channel 26 defines an opening that is approximately 2 inches by 12 inches. The channels 26 can be formed integrally with the plate 24 (such as by casting) or can be attached to the plate by welding or using suitable fasteners.

The frame 22 of the strap dispensing apparatus 18 is structured to support the strap reel 14. In one embodiment, the frame 22 includes main section 28 having a generally U-shaped configuration with first and second ends 28a,b. The main section 28 preferably is formed of tubular metal, such as steel, but can be formed of other materials provided the materials have sufficient strength to support the strap reel 14.

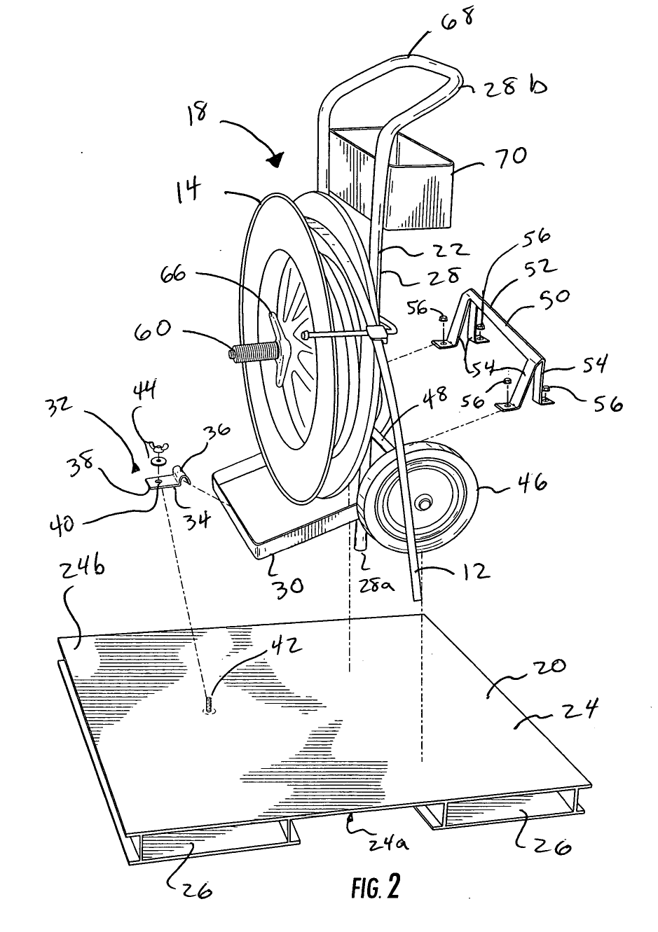

As illustrated in FIG. 1, the first end 28a of the main section 28 of the frame 22 is mounted to the second side 24b of the base member 24. For example, in one embodiment, the frame 22 includes a stabilizing member 30 attached to the first end 28a of the main section 28 that is structured to support the main section to thereby minimize wobbling of the main section and prevent the main section from tipping over. The stabilizing member 30 can be formed integrally with the main section 28 or can be attached to the main section by welding or using suitable fasteners. As illustrated in FIGS. 1 and 2, the stabilizing member 30 can be mounted to the second side 24b of the base member 24 using a first connector 32. In one embodiment, the first connector 32 comprises a removable clip 34 having a U-shaped portion 36 and a flange 38 extending therefrom. The concaved interior of the U-shaped portion 36 is structured to receive the stabilizing member 30 while the flange 38 includes an aperture 40 structured to receive a threaded member 42, such as a threaded post or bolt, projecting from the second side 24b of the base member 24. A fastener 44, such as a wing nut and washer, can then be attached to the threaded member 42 to thereby mount the stabilizing member 30 (and, thus, the first end 28a of the main section 28 of the frame 22) to the second side 24b of the base member 24.

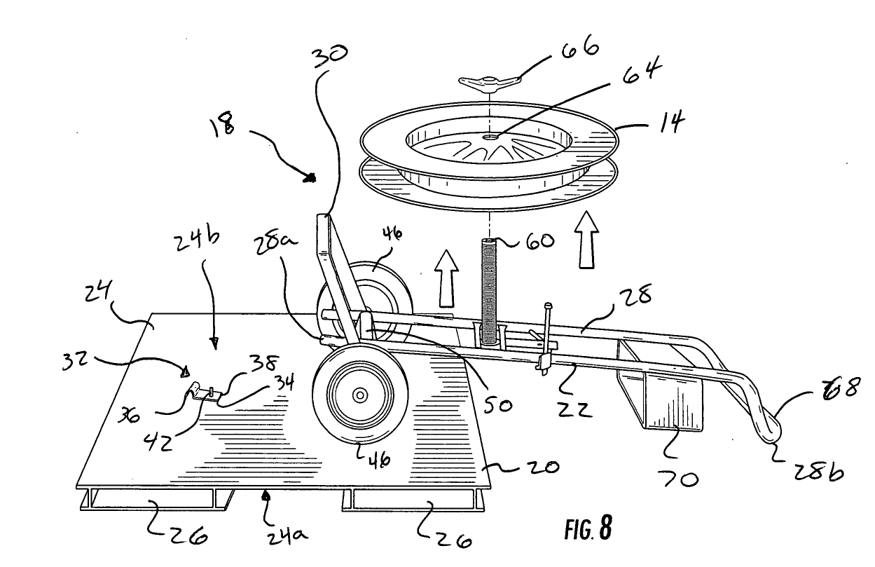

In one embodiment, the frame 22 is rotatably mounted to the second side 24b of the base member 24. For example, referring to FIGS. 1 and 4-7, the frame 22 can be rotated from a first position (see FIGS. 1 and 4), which is substantially vertical, to a second position (see FIG. 7), which is substantially horizontal. In one embodiment, the strap dispensing apparatus 18 includes a pair of wheels 46 with an axle 48 extending therebetween. Referring to FIGS. 2-5, the axle 48 is rotatably received in apertures defined by the stabilizing member 30 thereby rotatably mounting the wheels 46 and axle to the frame 22. As illustrated in FIG. 2, the strap dispensing apparatus 18 can include a second connector 50 structured to mount the axle 48 to the second side 24b of the base member 24. In one embodiment, the second connector 50 has a V-shaped configuration comprising an elongate member 52, such as a length of angle iron, with a pair of legs 54 extending from each end of the elongate member. The legs 54 and elongate member 52 can be formed integrally or can be joined by welding or using suitable fasteners.

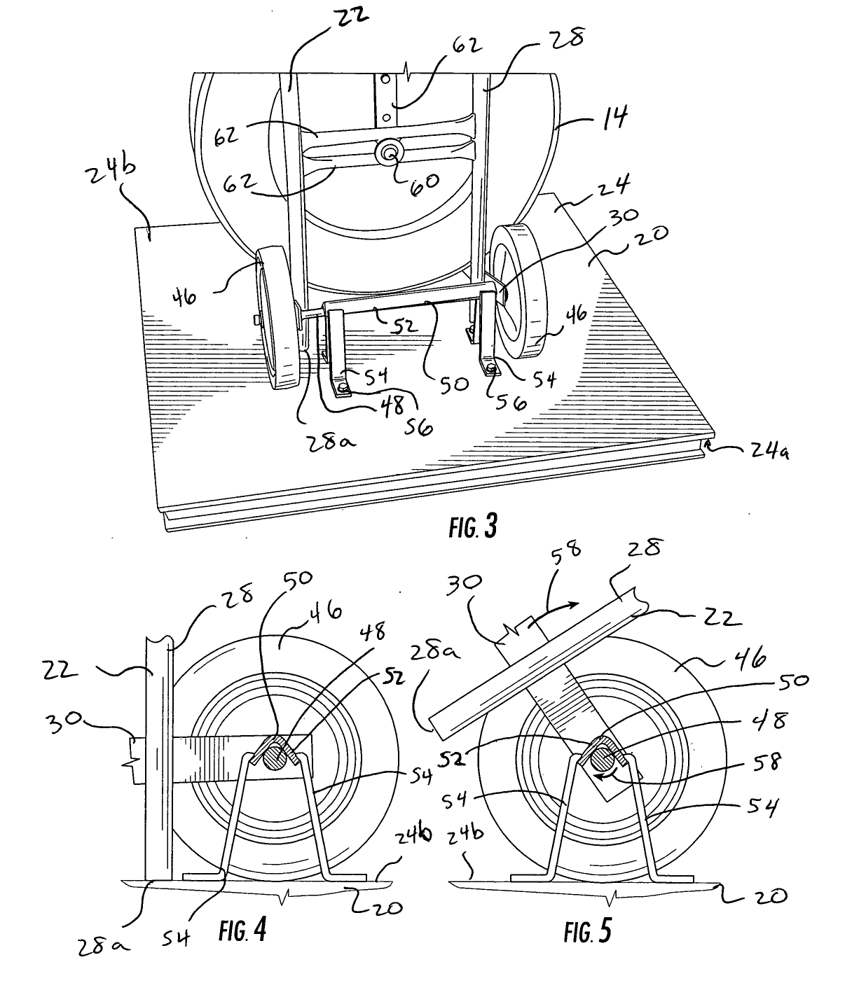

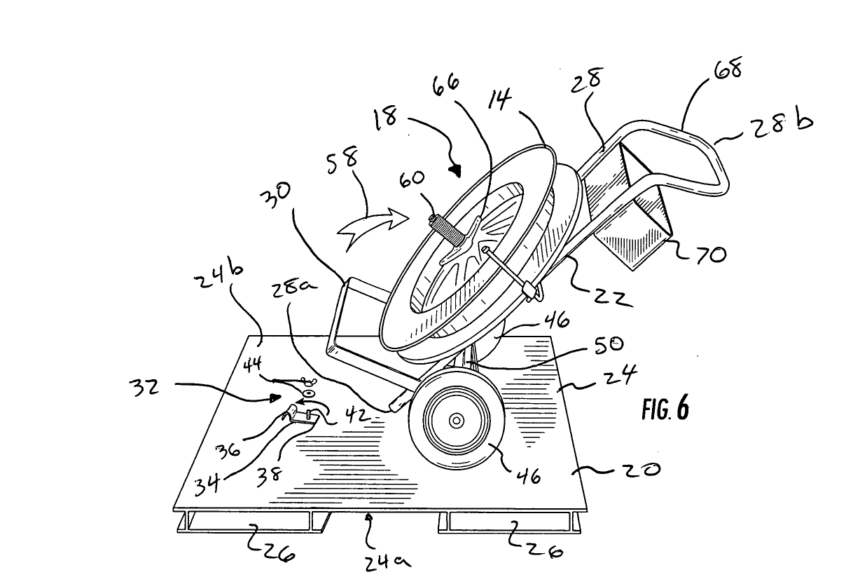

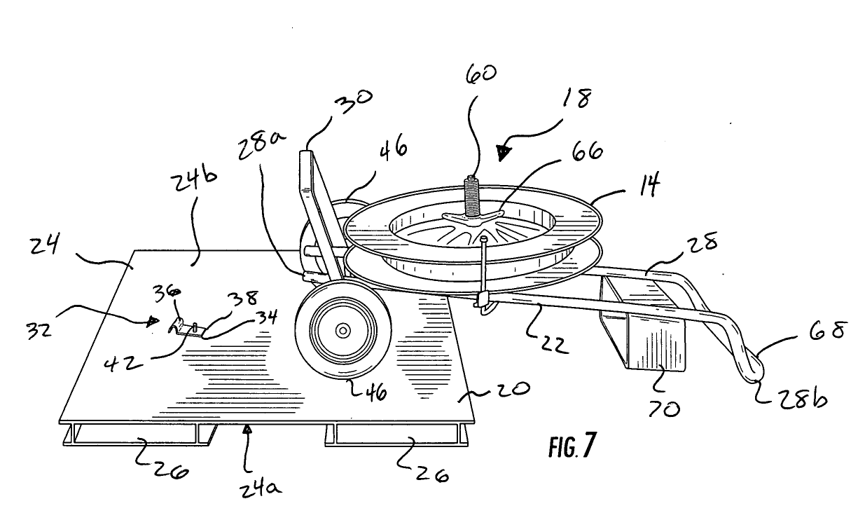

Referring to FIG. 3, the legs 54 of the second connector 50 and the second side 24b of the base member 24 include corresponding apertures structured to receive suitable fasteners 56, such as bolts or screws, to mount the second connector to the second side 24b of the base member. As illustrated in FIGS. 4-7, the elongate member 52 receives and rotatably holds the axle 48 thereby enabling the frame 22 to be rotated (see the arrows 58 in FIGS. 5 and 6) from the first position illustrated in FIG. 1 to the second position illustrated in FIG. 7.

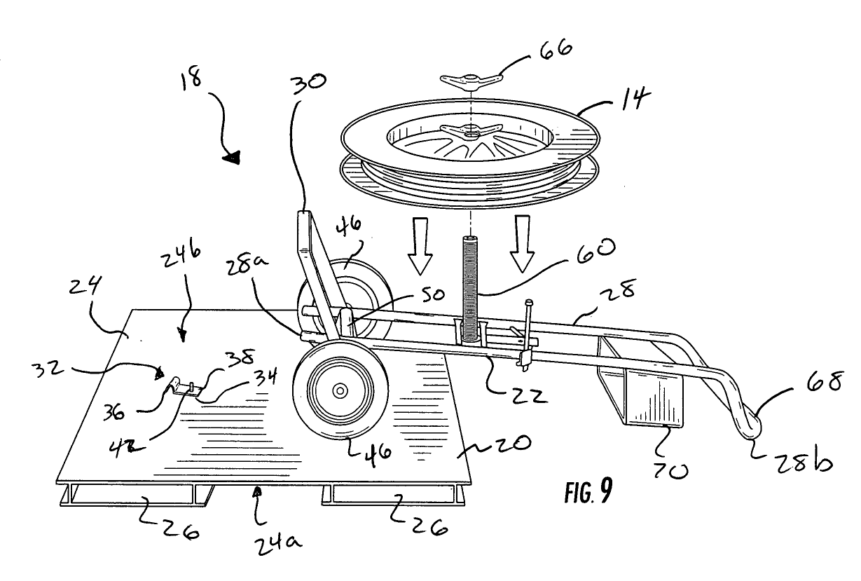

Referring to FIGS. 1 and 3, the strap reel 14 is removably mounted to the frame 22. In one embodiment, the frame 22 includes a threaded member 60 extending therefrom. As illustrated in FIG. 3, the main section 28 of the frame 22 can include one or more support members 62 to provide support to the threaded member 60. As illustrated in FIG. 8, the strap reel 14 defines an aperture 64 therethrough structured to receive the threaded member 60. The strap dispensing apparatus 18 includes a fastener 66, such as a wing nut, that is structured to threadably engage the threaded member 60 to thereby secure the strap reel 14 to the threaded member and, thus, the frame 22.

Other variations to the strap dispensing apparatus 18 are also considered to be within the scope of the present invention. For example, the second end 28b of the main section 28 of the frame 22 can be formed into a handle 68 and/or can include a storage box 70, as illustrated in FIG. 1. In addition, a strap guide with cutter 72, as is well known in the art, can be attached to the frame 22. The configuration and material used to form the frame 22 can vary provided the frame has sufficient strength and stability to support the strap reel 14. For example, although the frame 22 illustrated in FIGS. 1-10 is rotatably mounted to the second side 24b of the base member 24, in other embodiments (not shown), the frame 22 is mounted to the base member 24, either by forming the frame integrally with the base member or by weld the frame to the base member, such that the frame is fixedly attached thereto.

During operation, the strap dispensing apparatus 18 is transported from one location to another using the lifting device 16. In one embodiment, as illustrated in FIG. 10, the lifting device 16 comprises a forklift and the forks 16a of the forklift are inserted into the channels 26 of the base member 24 to thereby mount the strap dispensing apparatus 18 on the lifting device 16. Thereafter, the forklift is used to transport the strap dispensing apparatus 18, e.g., lift the strap dispensing apparatus, move the strap dispensing apparatus from one location to another, then lower the strap dispensing apparatus, to enable a user to dispense strap 12 as needed.

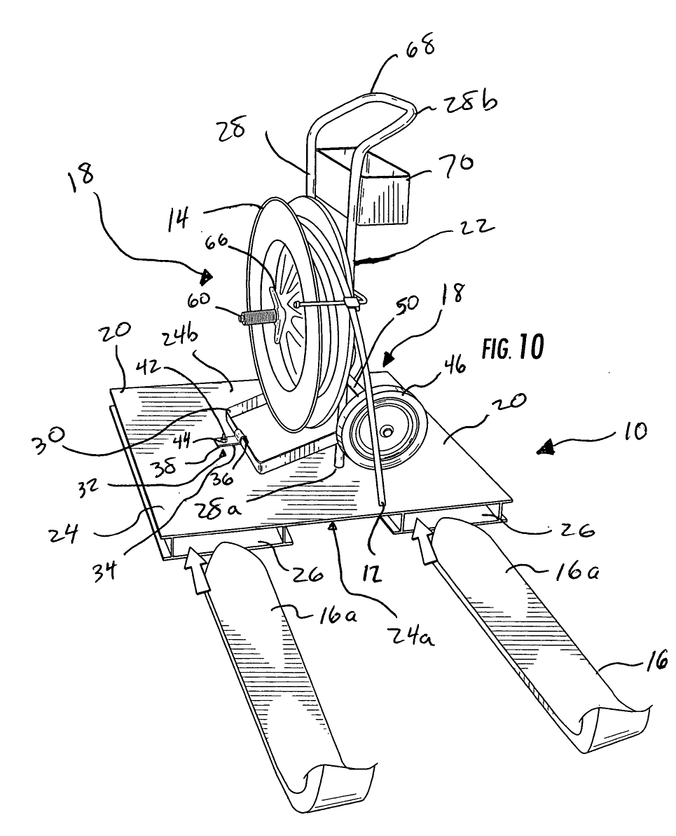

When the strap 12 on the strap reel has been depleted, the strap reel 14 can be easily and safely replaced according to the present invention. According to one embodiment, as illustrated in FIGS. 1 and 5-7, a first connector 32 is loosed from the stabilizing member 30 of the frame 22. Thereafter, the frame 22 is rotated from a first position to a second position on the base member 24 (see arrows 58 in FIGS. 5 and 6) wherein the first position is substantially vertical, as illustrated in FIG. 1, and the second position is substantially horizontal, as illustrated in FIG. 7. As illustrated in FIGS. 8 and 9, the strap reel 14 is then removed from the frame 22 and replaced with a strap reel that is loaded with strap. In one embodiment, the fastener 66 is removed from the threaded member 60, thereby enabling the strap reel 14 to be removed and replaced.

The fastener 66 can then be rethreaded onto the threaded member 60 to thereby secure the loaded strap reel. The frame 22 is then rotated from the second position to the first position and secured in place using the first connector 32. Thus, there is provided an apparatus and method that facilitates the portability of a strap dispenser without causing damage to the dispenser frame. The apparatus and method is cost-effective and commercially efficient, allowing workers to use the strap dispenser at several different locations in a short period of time and allowing the workers to easily and safely replace the strap reel. Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An apparatus for dispensing strap from a reel, the apparatus being transportable by a lifting device, the apparatus comprising:
a base member having first and second sides, said first side of said base member comprising at least one channel;
a frame mounted to said second side of said base member, said frame being structured to rotatably support the reel so that the strap can be dispensed; and
wherein said at least one channel is structured to be transportably engaged by the lifting device.

2. An apparatus as recited in claim 1 wherein said frame is rotatably mounted to said second side of said base member such that said frame can be rotated between first and second positions, wherein said first position is substantially vertical and said second position is substantially horizontal.

3. An apparatus as recited in claim 1 further comprising a pair of wheels and an axle extending therebetween, said pair of wheels and said axle being rotatably mounted to said frame.

4. An apparatus as recited in claim 3 further comprising a connector structured to mount said axle to said second side of said base member so that said frame is rotatably mounted to said base member.

5. An apparatus as recited in claim 4 wherein said connector has a generally V-shaped configuration.

6. A system for transporting and dispensing strap from a reel, comprising:
a lifting device;
a strap dispensing apparatus, comprising:
a base member having first and second sides, said first side of said base member comprising at least one channel; and
a frame mounted to said second side of said base member, said frame being structured to rotatably support the reel so that the strap can be dispensed; and
wherein said at least one channel is structured to be transportably engaged by said lifting device.

7. A system as recited in claim 6 wherein said frame is rotatably mounted to said second side of said base member such that said frame can be rotated between first and second positions, wherein said first position is substantially vertical and said second position is substantially horizontal.

8. A system as recited in claim 6 further comprising a pair of wheels and an axle extending therebetween, said pair of wheels and said axle being rotatably mounted to said frame.

9. A system as recited in claim 8 further comprising a first connector structured to mount said axle to said second side of said base member so that said frame is rotatably mounted to said base member.

10. A system as recited in claim 9 wherein said first connector has a generally V-shaped configuration.

11. A method for transporting a strap dispensing apparatus, comprising:
providing a strap dispensing apparatus having a base member with first and second sides, the first side of the base member comprising at least one channel, the strap dispensing apparatus further comprising a frame mounted to the second side of the base member, the frame being structured to rotatably support a strap reel so that the strap can be dispensed;
mounting the base member on the lifting device; and
transporting the strap dispensing apparatus with the lifting device.

12. A method as recited in claim 11 wherein said mounting step comprising inserting a fork of the lifting device in the channel of the base member.

13. A method as recited in claim 11 wherein said transporting step comprises lifting the strap dispensing apparatus with the lifting device.

14. A method as recited in claim 13 wherein said transporting step comprises moving the strap dispensing apparatus with the lifting device.

15. A method as recited in claim 13 wherein said transporting step comprises lowering the strap dispensing apparatus with the lifting device.

16. A method for replacing a strap reel on a strap dispensing device, comprising:
providing a strap dispensing apparatus having a base member, the strap dispensing apparatus further comprising a frame mounted to the base member, the frame being structured to rotatably support a strap reel so that the strap can be dispensed;
rotating the frame from a first position to a second position on the base member, wherein the first position is substantially vertical and the second position is substantially horizontal;
removing the strap reel;
replacing the strap reel; and
rotating the frame from the second position to the first position on the base member.

17. A method as recited in claim 16, further comprising releasing a connector securing the frame to the base member prior to said first rotating step.

18. A method as recited in claim 16, further comprising securing the connector securing the frame to the base member subsequent to said second rotating step.
